(19) United States
(12) Patent Application Publication
(10) Pub. No.: US 2003/0144940 A1
(43) Pub. Date: Jul. 31, 2003

(54) System and method for facilitating collateral management

(76) Inventors: Joseph M. Kochansky, New York, NY (US); Mitul Patel, Edison, NY (US)

Correspondence Address: CUMMINGS & LOCKWOOD, Attn.: Anita Lomartra, Granite Square, 700 State Street, P.O. Box 1960, New Haven, CT, 06509-1960, US

(21) Appl. No.: 10/323,133

(22) Filed: Dec. 19, 2002

Related U.S. Application Data
(60) Provisional application No. 60/351,679, filed on Jan. 25, 2002.

(51) Int. Cl. G06F 17/60

(52) U.S. Cl. 705/36

(57) ABSTRACT

A system and method for managing collateral proffered in support of transactions involving financial instruments, wherein the collateral management is conducted in an integrated setting with other systems providing analytical and trading capabilities. The system is configured to execute a method which includes receiving terms of an agreement relating to collateral support for a transaction, storing the terms of the agreement as data in an agreement database, computing an exposure value representing the risk of financial loss associated with the transaction, comparing the computed exposure value with the threshold exposure value and initiating a transfer of collateral based on the comparison of the computed value with the threshold exposure value.

### CROSS-REFERENCE TO RELATED APPLICATIONS

The subject application claims priority of commonly owned, co-pending U.S. Provisional Application Serial No. 60/351,679, filed Jan. 25, 2002, the disclosure of which is herein incorporated by reference in its entirety.

### BACKGROUND OF THE INVENTION

1. Field of the Invention

The subject disclosure is directed to a system and method for facilitating collateral management, and more particularly, to a system and method for managing collateral proffered in support of transactions involving financial instruments and integrated with other systems having analytical and trading capabilities.

2. Background of the Related Art

In general, collateral can be defined as an asset or a third-party commitment accepted by the collateral taker to secure an obligation of the collateral provider. The collateral is generally intended to protect the collateral taker (also referred to hereinafter as a “party”) against the default of the collateral provider (also referred to hereinafter as a “counter party”) in the underlying obligation. Thus, the party would keep the collateral to recoup its loss due to the counter party default, provided that the value of the collateral equaled the loss. Without “collateralizing” counter party obligations, the party assumes a credit risk by needlessly exposing itself to a potential loss if the counter party defaults. Furthermore, even if an obligation is collateralized, the party still assumes a credit risk if the value of the collateral is less than the value of the exposure at any time a default occurs.

The importance of credit-risk management, and how collateral management in particular offers protection to firms with credit exposures, is readily apparent thanks in large part to the steady stream of high-profile credit risk catastrophes and losses over the last few years, such as the Savings and Loans crisis in the early 1990's to the recent collapse of Enron. Billions of dollars were lost as a result of each scandal, and the backlash has driven the financial community to seek out and practice better credit risk management. Thus, collateral management has quickly become an essential tool for mitigating credit risks.

In addition to reducing credit risk, collateralizing also serves to protect investments and free up credit lines, thus allowing parties to expand their business by engaging in a greater amount of transactions. The inability to take advantage of opportunities can have detrimental financial consequences, especially in times of increased market competitiveness.

Collateral management as a risk reduction strategy is of critical importance when dealing in the derivatives market. Derivatives transactions are inherently vulnerable to credit-risk losses, as the payment on these trades is often a distant time period away, and with changing market conditions and credit ratings, the likelihood of default by a counter party, or at least the uncertainty of such default occurring, only increases. The assets that are usually accepted as collateral in agreements supporting derivatives transactions include government securities, traditionally U.S. Treasuries, and cash.

According to the 2001 Margin Survey conducted by the International Swaps and Derivatives Association (ISDA), the total amount of collateral in circulation in the derivatives markets exceeds $250 billion, representing a 25% increase over the previous year. In addition, the ISDA survey found that the total number of collateral agreements in place in the derivatives market for 2001 exceeded 16,000, which is a 45% increase from the previous year.

Since the amount of collateral in circulation and the number of collateral agreements being tied to transactions continues to grow, the need for more sophisticated collateral management technology is also increasing. In the past, collateral management has been maintained through database type applications. However, these applications typically lack the ability to determine and assess the theoretical risk values in order to monitor and move (i.e., take more or pay out) collateral in accordance with the terms of the original agreement. Also, in the past, the values were checked and re-calculated on a monthly basis. Due to market volatility, and to further limit the risk associated with these transactions, the current trend is to perform these calculations on a daily basis. Clearly, there is a need for a collateral management system that overcomes the problems of prior art systems.

The present invention provides a collateral management system that is, among other things, integrated with analytical and trading systems having databases which can determine the present risk and provide information regarding the present worth of the collateral. The present system provides a structure and incorporates a method which is capable of managing the collateral in accordance with the plurality of terms of the agreements that govern the party-counter party relationships.

### SUMMARY OF THE INVENTION

The present invention provides a method of managing collateral in conjunction with an integrated trading system and an integrated analytics system. The method includes the steps of: receiving terms of an agreement relating to collateral support for a transaction involving two parties and financial instruments; storing the terms of the agreement as data in an agreement database; computing an exposure value representing the risk of financial loss associated with the transaction; comparing the computed exposure value with the threshold exposure value; and initiating a transfer of collateral based on the comparison of the computed value with the threshold exposure value. The terms of the agreement stored in the agreement database relate to the collateral held, collateral pledged and one or more threshold exposure values for transferring the collateral support for the transaction between the collateral held and collateral pledged groups. All collateral held and pledged have a determinable present value.

The exposure value represents the risk of financial loss associated with the transaction and a method in accordance with the present invention may access current financial data using the integrated analytics system. In addition, a method according to the present invention may effectuate a transfer of collateral through the integrated trading system.

The aforementioned method of the present invention may further include the step of associating the agreement data with portfolio data relating to a portfolio of financial instruments. The portfolio data is stored in a portfolio database.

The aforementioned step of initiating a transfer of collateral based on the comparison of the computed value with the threshold value may include initiating a transfer of collateral equal to the difference between the computed exposure value and the threshold value in accordance with the present invention.

A method in accordance with the present invention may further entail the steps of initiating a transfer of collateral from collateral held to collateral pledged if the difference between the computed exposure value and the threshold value is positive, or initiating a transfer of collateral from collateral pledged to collateral held if the difference between the computed exposure value and the threshold value is negative.

In accordance with the present invention, the terms of the agreement may be entered in a database via a graphical user interface. Furthermore, the method of the present invention may include the step of communicating the result of the comparison of the computed exposure value to the threshold value to the parties involved in the agreement.

In another embodiment of the present invention, the aforementioned method includes the step of storing a minimum incremental amount for collateral transfer as a term of the agreement in the agreement database. In this embodiment, the step of initiating a transfer of collateral based on the comparison between the computed exposure value and the threshold value may further include initiating a transfer of collateral equal to the minimum incremental amount if the difference between the computed exposure value and threshold value is equal to or greater than the minimum incremental amount.

The present invention further provides a collateral management system integrated with financial instrument trading and analytics system components. The collateral management system includes: means for receiving terms of an agreement relating to collateral support for a transaction involving two parties and financial instruments; an agreement database for storing the terms of the agreement as agreement data; means for computing an exposure value representing the risk of financial loss associated with the transaction; means for comparing the computed exposure value with the threshold exposure value; and means for initiating a transfer of collateral based on the comparison of the computed exposure value with the threshold exposure value. The terms of the agreement may include collateral held, collateral pledged, and a threshold exposure value for transferring the collateral support between collateral held and collateral pledged.

A collateral management system constructed in accordance with the present invention may also include means for communicating the results of the comparison to the parties. The means for communicating the results of the comparison to the parties can include using the world wide web. In addition, the means for computing exposure values may be a data processor and the means for receiving agreement data can include a graphical user interface.

In another embodiment of a system constructed in accordance with the present invention, the collateral management system includes a portfolio database containing data relating to portfolios of financial instruments. Thus, the agreement data may be associated with the portfolio in the portfolio database.

In yet another embodiment of the aforementioned system, the means for initiating the transfer of collateral based on the comparison is through an associated trading system.

The present invention further provides a machine readable media for facilitating collateral management in support of transactions involving financial instruments. The media includes data segments for storing data relating to agreements governing collateral management relating to the transactions in an agreements database, a plurality of collateral and threshold values for initiating transfers of collateral from collateral held to collateral pledged. The media also includes code segments for performing an analysis of the transactions to determine credit risk exposure values relating to the transactions, comparing whether the credit risk exposure values are greater than the threshold values; and initiating a transfer of collateral based on the comparison of the determined credit risk exposure values to the threshold values.

These and other aspects of the system and method of the subject invention will become more readily apparent to those having ordinary skill in the art from the following detailed description of the invention taken in conjunction with the drawings.

### BRIEF DESCRIPTION OF THE FIGURES

So that those having ordinary skill in the art to which the present invention pertains will more readily understand how to make and use the method and system of the present disclosure, embodiments thereof will be described in detail herein below with reference to the drawings, wherein:

FIG. 1 is a schematic diagram depicting the core functional components of the computer-based collateral management system of the present disclosure;

FIG. 2 is a flow chart depicting the operational steps employed by a system and method in accordance with the present disclosure;

FIG. 3 is a flow chart illustrating the iterative process steps for initiating a transfer of collateral in accordance with a system and method of the present disclosure;

FIG. 4 illustrates an exemplary graphical user interface providing a tool for inputting agreement terms governing collateral management in support of transactions between a party and counter party, wherein the inputted data is stored in a database in accordance with the present disclosure;

FIG. 5 illustrates an exemplary graphical user interface providing a tool for inputting independent amounts of assets relating to agreements governing collateral management in support of transactions between a party and counter party, wherein the inputted data is saved in a database in accordance with the present disclosure;

FIG. 6 illustrates an exemplary graphical user interface providing a tool primarily for displaying the eligible collateral relating to agreements governing collateral management in support of transactions between a party and counter party in accordance with the present disclosure;

FIG. 7 illustrates an exemplary graphical user interface providing a tool for inputting eligible collateral or making changes to the eligible collateral shown in FIG. 6, wherein the inputted data is stored in a database;

FIG. 8 illustrates an exemplary graphical user interface providing a tool primarily for displaying the portfolios of financial instruments assigned to each agreement governing collateral management in support of transactions between a party and counter party in accordance with the present disclosure;

FIG. 9 illustrates an exemplary graphical user interface providing a tool for inputting portfolio assignments or making changes to the portfolio assignments shown in FIG. 8, wherein the inputted data is saved in a database;

FIG. 10 illustrates exemplary graphical user interfaces which provide tools primarily for displaying and customizing a summary report of collateral management information for agreements input into the database in accordance with the present disclosure;

FIG. 11 illustrates another exemplary graphical user interface primarily for displaying a summary report as shown in FIG. 10, depicting the processing options provided by the graphical user interface;

FIG. 12 illustrates an exemplary graphical user interface providing a tool primarily for displaying detailed and summary reports relating to all exposures, collateral pledged and collateral held in accordance with agreements input in the database of the present disclosure;

FIG. 13 illustrates an exemplary graphical user interface providing a tool for customizing the display of information shown in FIG. 12; and

FIG. 14 illustrates an exemplary graphical user interface providing a tool primarily for displaying collateral position reports for collateral held and pledged in accordance with agreements input in the database of the present disclosure.

### DETAILED DESCRIPTION OF THE PREFERRED EMBODIMENTS

The subject disclosure is directed to a new and useful tool for managing collateral as default insurance for transactions between a party and counter party in the form of a computerized system preferably integrated with an analytical system having an analytical engine configured to provide intra-day and inter-day real-time relative value analyses, credit risk analyses, and value at risk analyses, and a trading system configured to execute trades and the terms of the agreements governing the collateral provided for multiple portfolios of diverse fixed income securities and derivatives. For purposes of illustrating the features of the present invention, the embodiment discussed herein is intended to be operated by a corporate entity, partnership or person that engages in a transaction involving collateral with a counter party, which may be another corporate entity, partnership or person.

It should be understood that incorporating the present disclosure in an integrated system as described above is exemplary of the type of setting for which a system and method in accordance with the present disclosure is well-suited. Those skilled in the art will readily appreciate that a system and method configured in accordance with the present disclosure may be used in conjunction with other settings as well.

Those skilled in the art will also readily appreciate that a system in accordance with the present disclosure includes the various computer and network related software and hardware that may be used in a distributed computing network, that is, programs, operating systems, memory storage devices, input/output devices, data processors, servers with links to data communication systems, wireless or otherwise, such as those which take the form of a local or wide area network, and a plurality of data transceiving terminals within the network, such as personal computers. Those skilled in the art will further appreciate that, so long as its users are provided with access to a system and method constructed in accordance with the present disclosure, the type of network, software or hardware is not vital to its full implementation.

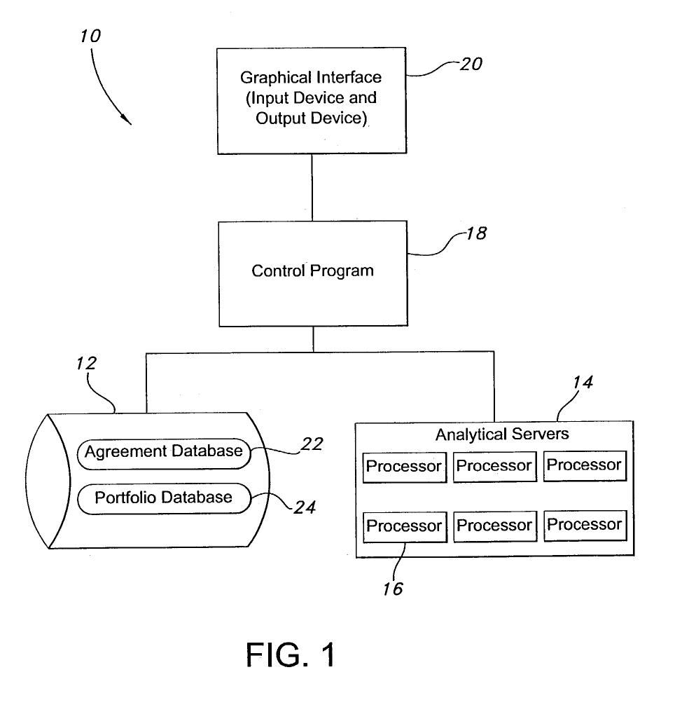

Referring now to the drawings wherein there is a schematic representation illustrated in FIG. 1 of the core functional components of a collateral management system constructed in accordance with the subject disclosure designated generally by reference numeral 10. It should be understood that system 10 is adapted and configured to function independently while also interacting with other systems such as systems for performing market analysis and the trading of financial instruments, including trading platforms capable of actualizing trades of financial instruments via the world wide web. In particular, system 10 provides, preferably through graphical user interfaces, a collateral management system for daily or upon demand evaluations of present risk and adjustment of collateral in accordance with such evaluations.

Preferably, the graphical user interfaces (also referred to herein as “screens”) used by system 10 incorporate user-friendly features and fit seamlessly with other operating system interfaces, that is, in a framed form having borders, multiple folders, toolbars with pull-down menus, embedded links to other screens and various other selectable features associated with animated graphical representations of depressible buttons. These features can be selected (i.e., “clicked on”) by the user via connected mouse, keyboard, voice command or other commonly used tool for indicating a preference in a computerized graphical interface.

System 10 includes a data storage device or memory 12 and an analytical server 14 having a processor 16 which is operatively associated with the memory 12 via control program 18 for managing the flow of data throughput. Alternatively, and as shown in the embodiment of the present invention depicted in FIG. 1, a plurality of analytical servers 14 and processors 16 may be associated with memory 12 and control program 18 to operate system 10. Data input and output devices 20, collectively referred to herein as a graphical interface, are operatively associated with the memory 12 and server 14 for performing functions through control program 18, such as receiving and reporting data in accordance with the present invention. Program 18 contains an instruction set written in a conventional computing language such as HTML, C++ or Java, for coordinating the interactive relationship between memory 12, processors 16, and graphical interface 20.

Memory 12 may contain a plurality of cooperative relational databases. For example, this embodiment has an agreement database 22 for storing a plurality of agreements wherein each agreement relates to the management of collateral assigned to cover the risk created by engaging in the transaction with the counter party and a portfolio database 24 for information relating to the portfolios of financial instruments which may be effected by the transaction with the counter party. The portfolio database 24 and/or agreement database 22 may also be integrated with the analytical and trading systems.

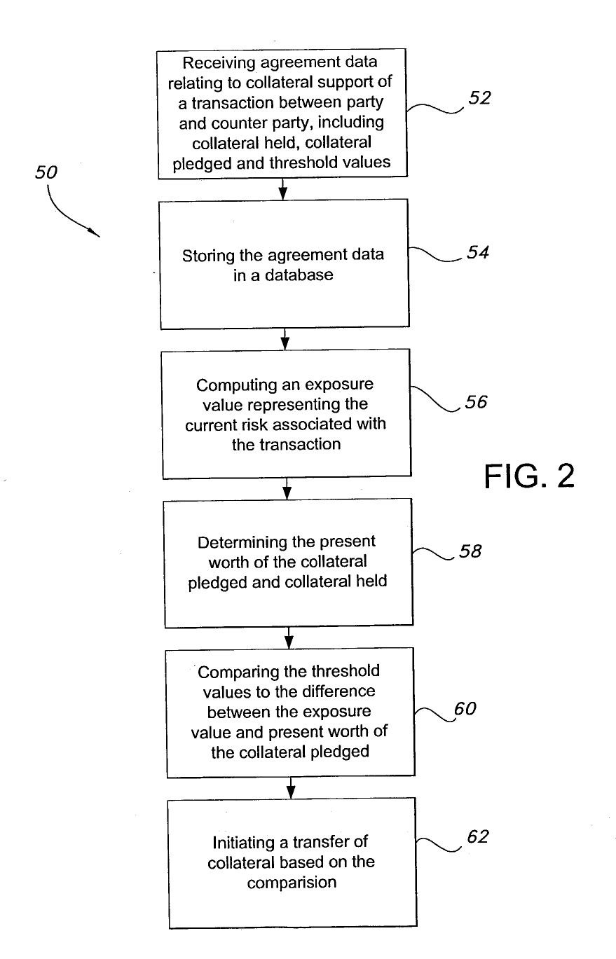

Referring now to FIG. 2, there is illustrated a process flow chart 50 depicting the operational steps employed in a preferred embodiment of a system and method in accordance with the present disclosure, wherein an agreement governing collateral support is input into system 10 in association with a transaction involving financial instruments. An example of the type of financial instruments for which a collateral agreement might be employed are over the counter (OTC) derivatives. OTC derivatives are financial instruments whose characteristics and value depends upon the characteristics and value of an underlying instrument or asset (typically a commodity, bond, equity or currency), which is not traded on an exchange, usually due to an inability to meet listing requirements. For such securities, broker/dealers negotiate directly with one another over computer networks and by phone, and their activities are monitored by the National Association of Securities Dealers (NASD).

Upon receipt by system 10 in step 52 of agreement data relating to terms of the agreement governing the credit support (i.e., collateral) for a transaction between a party and a counter party. In this embodiment, the transaction also involves a portfolio stored in the portfolio database 24. The agreement may also include, among other things, data relating to the collateral held as credit (i.e., available for further credit support), collateral pledged (i.e., collateral already turned over to cover the exposure) and threshold values for initiating a transfer of collateral (also known as a collateral margin call) between collateral held and collateral pledged. The collateral held or pledged may include, alone or in combination, cash, real property, financial instruments. The collateral may also include other assets which change in value depending on market conditions, but nonetheless, have a determinable value ascertainable through computation or analysis of market or time-sensitive factors. In addition, the agreement may contain several other terms or provisions that modify or otherwise effect the calculations and ultimate determination of whether a collateral transfer should occur. For example, the agreement may contain terms relating to independent amounts, collateral “haircuts”, various thresholds for minimum or maximum transfer amounts, or rounding of calculated amounts, all of which are discussed in further detail below.

In step 54, the agreement data is stored in database 22. In step 56, processor 16 calculates an exposure value representing the current risk to the party associated with the transaction. For example, in the case of a transaction involving derivatives, a mark-to-market analysis may be conducted on all open derivatives. In step 58, the present worth of all collateral held and pledged is determined by processor 16 based on present market conditions in accordance with terms of the agreement and any modifying terms therein. In step 60, the threshold values specified by the agreement are compared to the difference between the calculated exposure value and present worth of the collateral pledged, if any. Based on the results of the comparative analysis conducted in step 58, and in accordance with the terms of the agreement, system 10 may initiate a transfer of collateral from held to pledged, or vice versa, in step 62. Preferably, any transfers of collateral are executed in a manner which maintains a status quo such that the net difference between the value of collateral pledged and the exposure value is substantially zero.

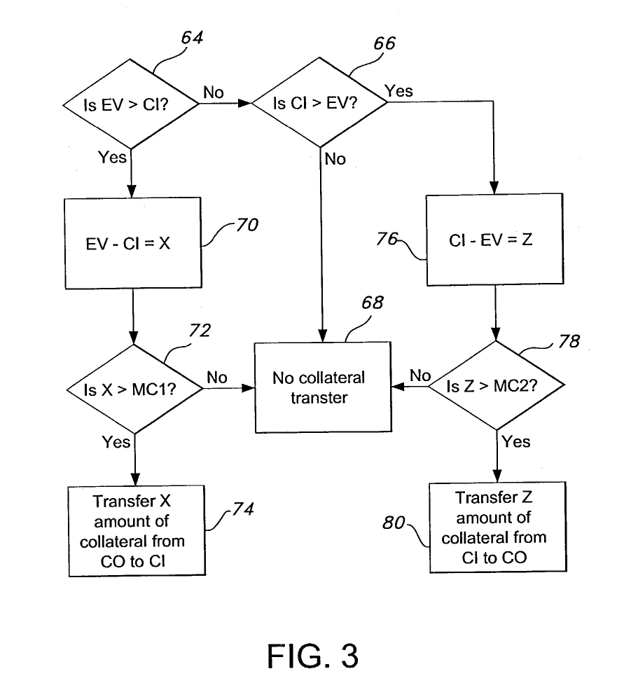

FIG. 3 provides a flow chart which illustrates the basic steps of a portion of the analysis conducted by processor 16 in steps 58 and 60. In steps 64 and 66, the calculated exposure value (“EV”) is compared to the present worth of the collateral pledged (“CI”) to determine the greater amount. If the two values are equal, then the analysis would determine that no collateral transfer is necessary, as shown in step 68.

If there is a credit support deficit (i.e., the calculated exposure value is greater than the present worth of the collateral pledged), then the difference in value between the exposure value and collateral pledged is determined in step 70. For purposes of facilitating the illustration in FIG. 3, the difference between the exposure value and collateral pledged is represented by “X”, and is also referred to herein as “the difference X.” In step 72, the difference X is compared with the threshold value for a collateral margin call (“MC1”), per the terms of the agreement stored in database 22. If the difference X is greater than MC1, then a transfer of collateral is initiated from collateral held (“CO”) to collateral pledged. As shown in step 74, the collateral transferred from CO would have a present value that substantially corresponds to the difference X, unless the terms of the agreement specified otherwise. If the results of the comparative analysis in step 72 show that the difference X is less than MC1 then no collateral transfer is initiated in step 68.

Returning to steps 64 and 66, if there is a credit support surplus (i.e., the present worth of the collateral pledged is greater than the calculated exposure value), then the difference between the collateral pledged and exposure value amount is determined in step 76. For purposes of facilitating the illustration in FIG. 3, the difference in value between the collateral pledged and calculated exposure value is represented by “Z”, and is also referred to herein as “the difference Z.” In step 78, the difference Z is compared with the threshold value for a counter party collateral margin call amount (“MC2”), per the terms of the agreement stored in database 22. If the difference Z is greater than MC2, then a transfer of collateral is initiated from CI to CO. As shown in step 80, the collateral transferred from CI would have a present value that substantially corresponds to the difference Z, unless the terms of the agreement specified otherwise. If the results of the comparative analysis in step 78 show that the difference Z is less than MC2, then no collateral transfer is initiated in step 68. It should be noted that MC1 and MC2 may in fact be of equal value. The collateral transfer may also include communicating a collateral “call” to the counter party notifying of the need to perform a collateral transfer.

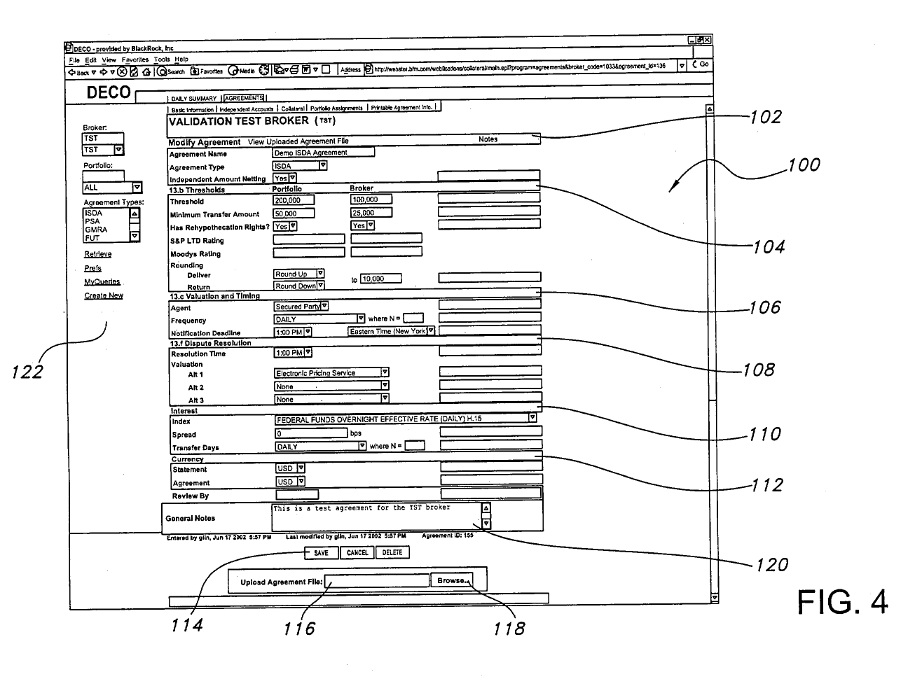

FIGS. 4-14 illustrate exemplary and preferred graphical user interfaces which may be used in conjunction with a method and system constructed in accordance with the subject invention. In this embodiment, one party represents the interest of a portfolio of financial instruments, and is referred to as “Portfolio” in some of the graphical user interfaces, while the counterparty is also referred to as a “Broker” in some of the graphical user interfaces.

FIG. 4 illustrates a screen 100 that may be used to capture the terms of the agreements governing collateral management into database 22 of system 10. Screen 100 contains fields for data entry, each of which may be used as a variable in a search for agreements in database 22. Preferably, the fields are organized and labeled to substantially reflect and simulate standard agreements commonly used in the industry, many of which are developed and updated by the various trade associations such as the ISDA, to facilitate entry of all key credit support terms. In this embodiment, screen 100 depicts what is known as an ISDA agreement in a format comparable to the form set forth in the Credit Support Annex of the ISDA master agreement.

Data may be entered into screen 100 or chosen from menus triggered by the mouse or keyboard strokes. In general, the agreement section 102 permits the user to identify the agreement by name and type. The agreement name can be used to identify the agreement in all further screens which display information related to that agreement. The agreement name may also be used to retrieve agreement data from database 22. Preferably, system 10 also assigns a unique internal identification number for the agreement. The format of screen 100 may change depending on the underlying transaction and type of agreement selected (e.g., ISDA, PSA, FUT, GMRA, etc.), to simulate the standard format for that type of agreement. As shown, section 102 also provides fields for indicating whether an independent amount can be netted with the total exposure value. In this embodiment, the default answer for this particular parameter is “Yes”. If the independent amount cannot be netted, then it is moved separately from the collateral calls such that collateral may be received by a party (the “portfolio” in the figures for this embodiment) at the same time that an independent amount is delivered to the counter party (the “broker” in the figures for this embodiment). Non-netted independent amounts are also know as minimum independent amounts and are not subject to the threshold value for collateral margin call or minimum transfer amount.

The thresholds section 104 provides fields for the threshold amount which is the maximum unsecured exposure amount the portfolio and broker involved in the agreement are willing to accept. When exposure exceeds these thresholds, collateral calls may be made. As shown in FIG. 4, a value is entered separately for the portfolio and broker. The minimum transfer amount is entered into the corresponding fields in section 104 for the portfolio and broker and represents the minimum monetary increment for transferring collateral. Thus, a credit support surplus or deficit must exceed a respective threshold by at least the minimum transfer amount for a collateral call to be triggered. Section 104 also contains portfolio and counter party drop-down menu fields for selecting whether re-hypothecation rights are allowed, that is, if either party has the right to re-pledge the collateral it receives. The current long-term S&P and/or Moody's ratings may be entered separately for the portfolio and broker in corresponding fields in section 104. Section 104 also provides drop-down menu fields for entering the rounding rule to be used in calculations for credit support. The manner in which monetary amounts are to be rounded can be specified independently for the delivery and return of collateral. In this embodiment, the rounding options are none, round to nearest number place (as entered in a field in section 104), round up and round down. The default values for rounding are to round up for delivery and round down for return to the ten thousandths place, as shown in FIG. 4.

Section 106 in screen 100 generally includes fields for selecting the valuation and timing terms of the agreement. The party responsible for calculating the margin call and for notifying the other party of any required collateral transfers is input into the agent drop-down menu field. The default is “Secured Party” (i.e., the party in whose favor there is a security interest, which has been referred to herein as the “party”) but other values are available, such as “Broker” and “Portfolio.” Section 106 includes a drop-down menu field for selecting the frequency of valuation calculations and margin calls (e.g., daily, weekly, monthly, nth business day of the month, etc) with “Daily” being the default value. The time by which a party would need to notify the other of collateral calls is selected in the notification deadline field. In this embodiment, a drop-down menu provides time intervals on the half-hour, as well as time zones. The selected time zone is applied to all time fields on the agreement. The default for this field is “1:00 PM Eastern Time.”

Section 108 generally includes fields for selecting the manner in which disputes are to be resolved. The time by which a valuation dispute must be resolved may be selected from a drop-down menu which provides time intervals on the half-hour, with the default value being “1:00 PM Eastern Time.” The valuation field indicates the calculation method agreed to by both parties to resolve a valuation dispute. In this embodiment, three possible alternatives for valuation are provided, and each of the alternatives may be selected from drop-down menus having the following options: “Electronic Pricing Service”, “Mean Market Maker Closing Price”, “Mean Market Maker Bid/Ask”, “Prior Day Electronic Pricing Service”, “Prior Day Mean Market Maker Closing Price”, “Prior Day Market Maker Bid/Ask”, and “None”. The default values are “Electronic Pricing Service” for the alternative 1 field and “None” for alternatives 2 and 3, as shown in FIG. 4.

Section 110 generally includes fields for entering the agreed upon terms regarding the treatment of interest on the collateral. The interest rate used for calculating interest on collateral held can be selected from the drop-down menu in the index field. The menu may include available rates from various economy database tables, such as those used with the trading and analytical systems integrated with the present embodiment of the subject invention. The default value is “Federal Funds Overnight Effective Rate (Daily) 11.15.” In the spread field, the basis points added to or subtracted from the interest rate index, if any, are selected. The default for this field is 0 basis points. The agreed upon frequency of interest calculations on collateral (e.g., daily, weekly, monthly, nth business day of the month, etc) is input in the transfer days field.

Section 112 includes fields for entering the terms relating to the currency used for all exposure and credit support calculations and reporting. In this embodiment, drop-down menu lists are provided with various currencies for selection. The currency in which the terms of the credit support agreement are written is selected in the agreement field in section 112. The currency in which calculations will be conducted and results reported is entered in the statement currency field. The default values for both are United States dollars. If the agreement currency differs from the statement currency, it will be converted to the statement currency for the calculations according to the applicable current exchange rate obtained through the integrated systems in this embodiment.

Once all the desired information is entered or selected in the fields in section 102 through section 112, the agreement can be saved in database 22, cancelled or deleted from database 22, by making the appropriate selection (save, cancel or delete) in button bar 114. Agreements that are saved in database 22 may be uploaded by entering the agreement name in the upload agreement field 116, among other ways. The agreements in database 22 may also be browsed by pressing the browse button 118. As shown in screen 100, each section 102 through 112 contain a plurality of fields for entering notes about the various terms to be entered. A general notes field 120 for entering general agreement related notes is also provided.

A side window 122 framed independently of sections 102 through 112 in screen 100 includes fields for conducting searches and retrieving agreements from database 22. Information regarding the current agreement and links to other areas of system 10, including links to system options such as changing general preferences, are also included in window 122. In this embodiment, searches using window 122 may be based on broker, portfolio and agreement type by entering names in fields or selecting names from drop-down menus.

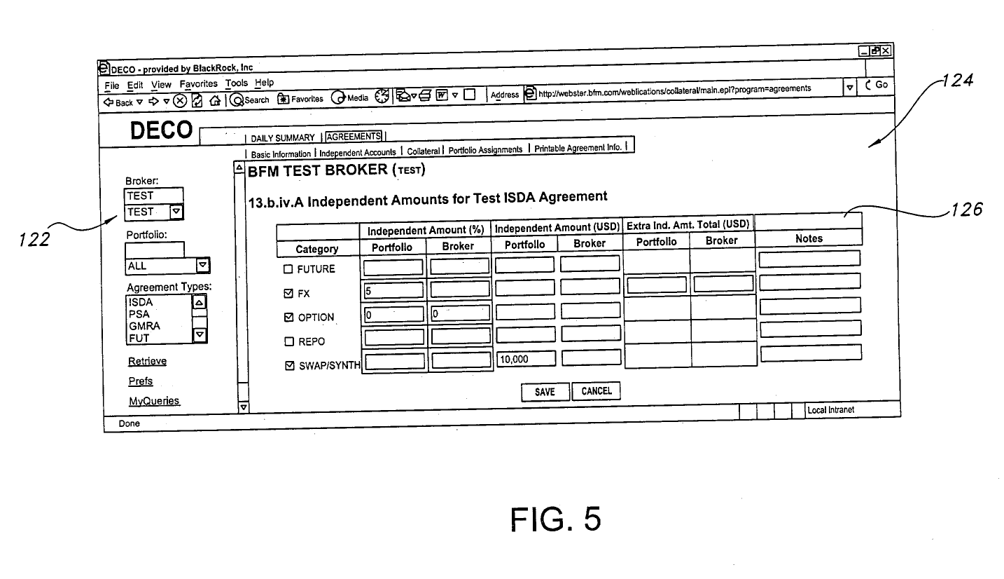

FIG. 5 illustrates a screen 124 useful for specifying the types of securities to be covered by the agreement and any independent amounts that can also be applied to transactions covered under the agreement. Generally, independent amounts are specified for transfer to one party only, and usually it is the party with the better credit. In this embodiment, table 126 includes fields for entering amounts as a percentage of notional (i.e., the predetermined principal on which the exchanged interest payments are based in an interest rate swap) or a total dollar value. Independent amounts are commonly specified in these types of agreements as a percentage of notional at the security level and as total dollar value at the agreement level.

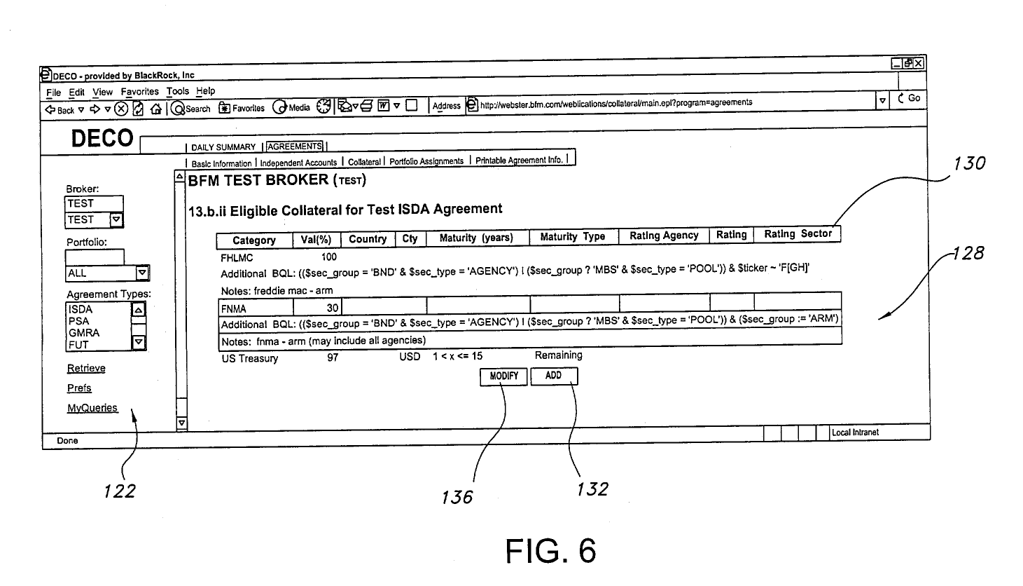

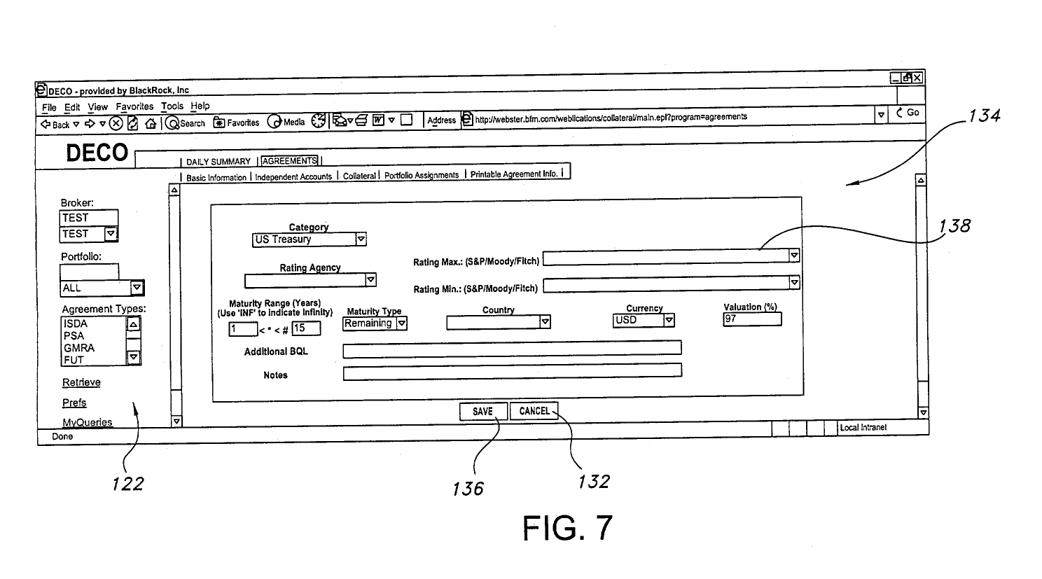

FIGS. 6 and 7 illustrate screens for entering data regarding all of the types of securities that are eligible to be pledged or held as collateral. Screen 128 in FIG. 6 includes a table 130 listing the security data in tabular form. Securities may be added to table 130 by pressing add button 132, which opens a screen 134 shown in FIG. 7. Similarly, the information regarding the securities listed in table 130 may be changed by pressing modify button 136 in screen 128 which opens screen 134. Each security covered by the agreement is entered or modified by entering data in form 138 of FIG. 7. Form 138 includes fields for entering ratings, maturity range, and drop-down menus for selecting common security criteria facilitate data entry regarding each security covered by the agreement. Customized codes may also be used to input very specific types of securities, if necessary. Form 138 also includes fields for entry of data used in the calculations, such as the haircut (or valuation) percentage. Typically, all collateral that is posted to a portfolio but not eligible will be valued at zero. The entered data may be saved to database 22 or cancelled by pressing the appropriate save or cancel buttons depicted in screen 134.

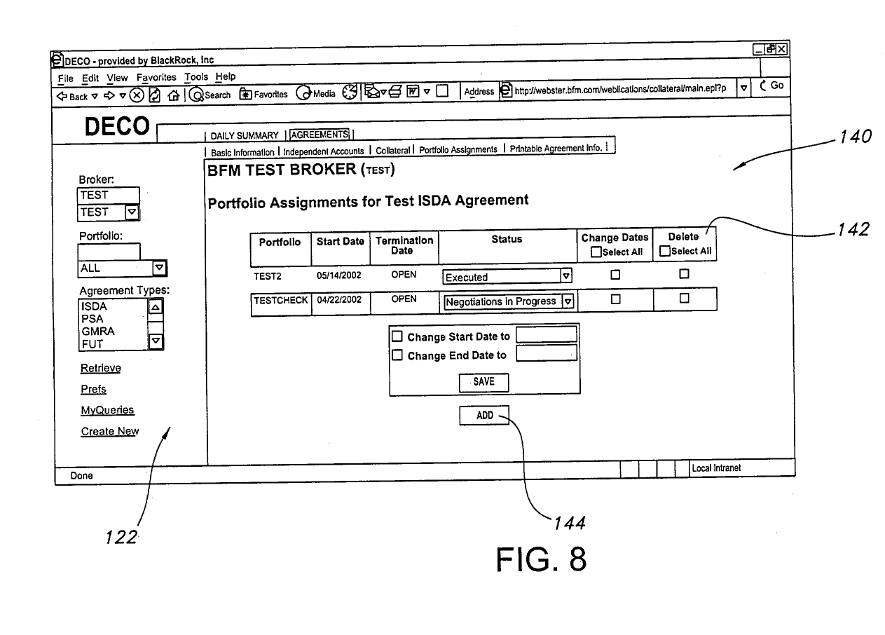

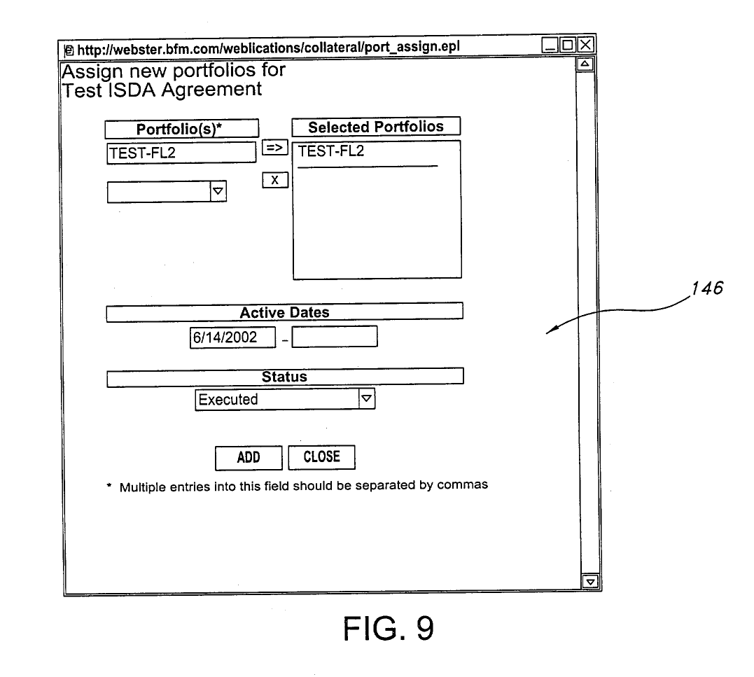

FIGS. 8 and 9 illustrate screens for assigning portfolios in database 24 to be covered by the agreement. Screen 140 in FIG. 8 includes a table 142 having a list of portfolios which have been assigned to the agreement. Table 142 provides information such as a start date and end date for each portfolio assignment, and further includes drop-down menus for indicating status. Table 142 includes options for deleting portfolios and changing the aforementioned dates. The credit support calculations will only apply the terms of the agreement with regard to the assigned portfolios when the calculation date is between the start and end date of the portfolio assignment. Further portfolio assignments may be added by pressing add button 144, which opens a screen 146 shown in FIG. 9. The portfolio database 24 may be searched and portfolios assigned to the agreement using screen 146. The active dates and status may also be selected in screen 146.

Once all the information is entered in association with the agreement, the data is saved as agreement data in database 22. Credit support calculations can then be performed by processor 16 in accordance with the terms of the agreement data entered into section 106 of screen 100. Credit support calculations are typically performed daily for all portfolios associated with agreements in database 22. Preferably, portfolios without agreements are also processed and available for reporting, with the collateral call amounts defaulting to the minimum transfer amounts.

Financial data regarding each security listed in table 130 as of the previous day (relative to the calculation date) is retrieved, and the exposure is calculated for each trade. The financial data including prices and/or trade information is obtained from sources or databases associated with the integrated analytical and trading systems. Preferably, the calculations are conducted in the morning, prior to market open. Therefore, for purposes of the calculations, all trades are included and added to the exposure on the trade date plus one, and all trades are removed from the exposure on the settlement date plus one. Independent amounts are also calculated for each trade. Data relating to transactions involving collateral are also retrieved. This includes all settled collateral trades, pending collateral that have not matured, cash posted as collateral for trades and all failed collateral trades. Haircuts are applied, if appropriate, to calculate the current market value of collateral already pledged. All exposure and collateral values are converted into the statement currency, preferably by using the exchange rates from market close of the previous day.

The margin call is calculated using the calculated exposures, independent amounts, market values of all outstanding collateral, thresholds and minimum transfer amounts in accordance with the agreement terms, as indicated in sections 102 through 112 of screen 100. Independent amounts are netted with exposures, if permitted under the section 102. The sum is then compared to the threshold and minimum transfer amounts indicated in section 104. Exemplary formulas are shown below:

Formulas—Trade Level

Exposure (MTM)=Current Par*Price*Price Multiplier*Exchange Rate

Collateral Value=(Price+Interest Base)*Current Par*Price Multiplier*Exchange Rate Valuation Percentage

Formulas—Portfolio Level

Total Exposure=Sum of Individual MTMs+Sum of Nettable Independent Amts

Gross Credit Support=Total Exposure—Threshold

If greater than zero, the difference is the Gross Credit Support

Net Credit Support Required=Gross Credit Support—Collateral Outstanding

Margin Call=Evaluate Net Credit Support Required vs. Minimum Transfer Amount

If Net Support less than Minimum Transfer Amount, no call

If Net Support greater than Minimum Transfer Amount, the net amount is called

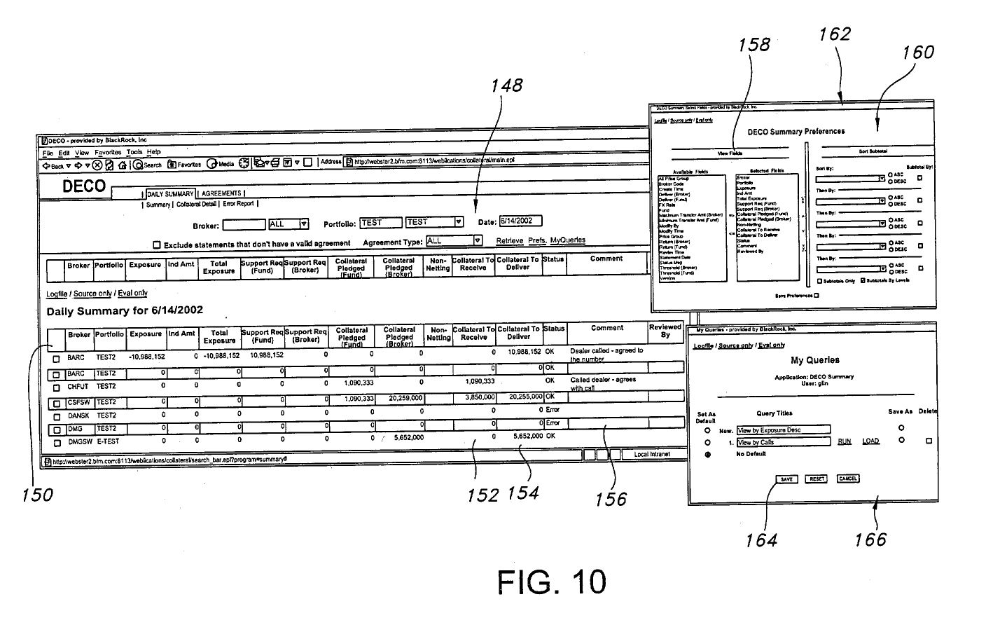

FIG. 10 illustrates a screen 148 that includes a daily collateral summary report table 150. Table 150 provides a listing of information regarding the broker and portfolio exposure for each agreement. The collateral to receive and collateral to deliver operations are shown in columns 152 and 154, respectively. Preferably, status messages, such as errors which may occur, for example because of missing information, are color-coded so that they may be quickly identified for further investigation and processing. Also, each portfolio name is preferably linked to the underlying detailed statement. The status of the margin call operation is provided in comment column 156.

Summary report table 150 can be customized using preference selection fields 158 and sorting option fields 160 in screen 162 and/or the “My Queries” fields 164 shown in screen 166 to specify desired columns, sorting and sub-totaling for table 150. In this embodiment, summary reports such as that shown in screen 148 can be retrieved for a specific date, broker and portfolio or portfolio group. Reports may also be generated for only those portfolios in database 24 with active credit support agreements or also be retrieved for all portfolios and brokers in system 10 and single or multiple statements can be selected for bulk actions.

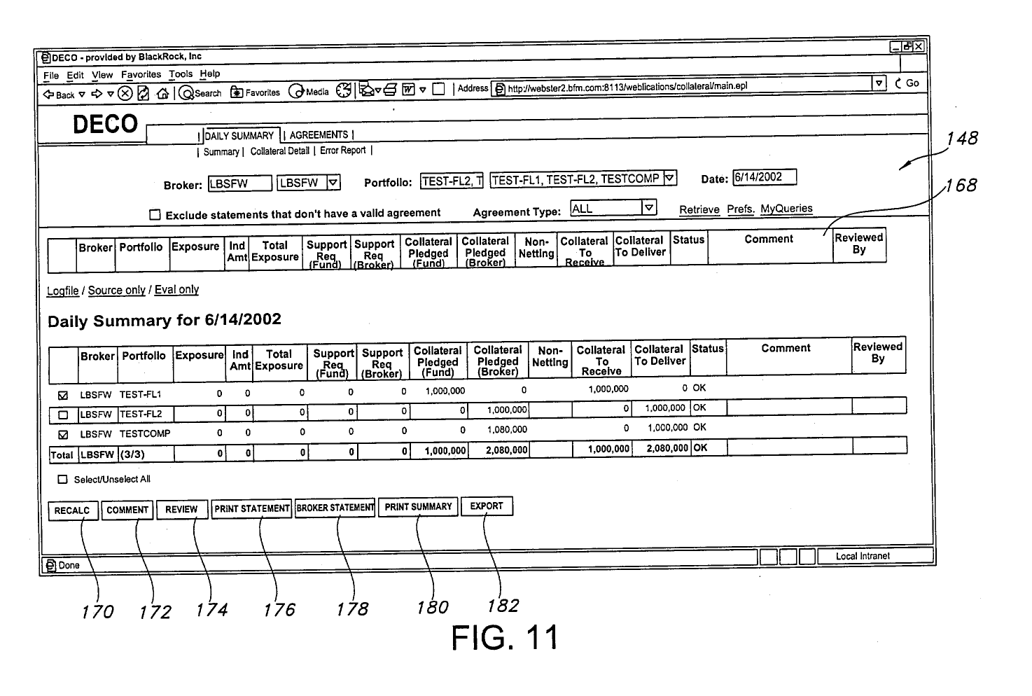

FIG. 11 illustrates the options available in the lower portion of a screen 148 having a daily collateral summary report table 168. The recalculation button 170 permits the user to recalculate the selected statements in table 168 according to the terms of the applicable agreement in database 22. The comment button 172 allows for entry of a comment, or overwriting a previously entered comment, for the selected statements in table 168 to be displayed on screen 148. The review button 174 allows the selected statements in table 168 to be reviewed and approved. Once approved, no further changes can be made to these statements. The print statement button 176 formats selected statements included in table 168 into a printer-friendly and/or email-friendly format and provides links for executing the desired operation. The broker statement button 178 formats selected statements in table 168 into the current standard for broker statements for subsequent transmission to the broker via email, fax or letter. The print summary button 180 formats the entire summary table 168 into a printer-friendly and/or email-friendly format and provides links to execute the selected operation. The export button 182 provides the option of exporting the selected statements in table 168 into formats for other programs, such as word processing, spreadsheet, money management software.

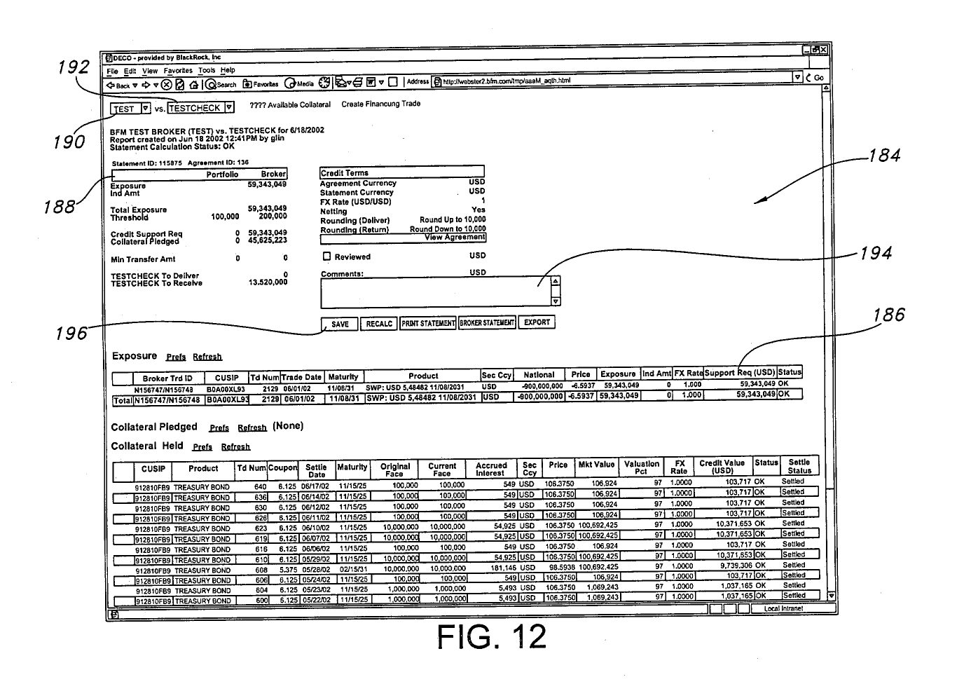

FIG. 12 illustrates a screen 184 including a table 186 that provides a detailed statement and a table 188 that provides a summary of calculations for all portfolios and broker assignments shown in table 142 of FIG. 8. Similar statements may be generated for each agreement in database 22 and for other portfolio and broker combinations by choosing a broker and portfolio in drop-down menus 190 and 192, respectively. Table 186 includes detailed trade-level exposure information for all trades or transactions that contribute to the total exposure in summary table 188. Detailed trade-level information for all outstanding collateral pledged is also listed in table 186. Since there is no collateral pledged in this sample screen 184, the term “(None)” is displayed instead. Collateral held (i.e., collateral “pledged out”) is also listed in detail in table 186. Table 188 provides a summary list of portfolio-level calculations and key credit support terms, such as the exposure, independent amounts, threshold values, credit support required (i.e., collateral necessary), minimum transfer amounts, amount to deliver or receive, for both portfolio and broker are displayed, along with pertinent agreed upon terms such as netting, currency and rounding, in table 188. Preferably, the net collateral to deliver or collateral to receive are highlighted or otherwise easily distinguished from the surrounding data.

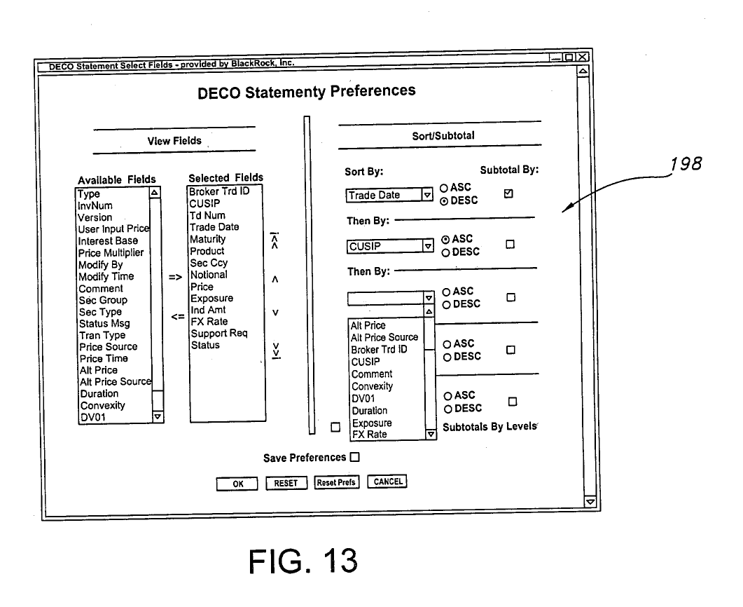

Comments can be entered in field 194 to save information and communicate work performed on the statement. The button bar 196 includes a print statement button for generating a version of the screen 184 that is printer-friendly and email-friendly for subsequent transmission. Bar 196 includes a broker statement button for generating a version of the screen 184 formatted specifically for transmission to brokers and other external parties. Preferably, the broker-formatted statement displays only the information relevant to the broker and aggregates collateral positions by CUSIP number. Button bar 196 also includes buttons so that individual statements such as that shown in screen 184 can be saved, re-calculated, emailed or exported directly to another program. In this embodiment, various data on screen 184, such as the trade number, is linked to databases 22 and 24, along with other portions of system 10 and the analytical and trading systems. FIG. 13 illustrates a screen 198 for setting preferences relating to screen 184 such as column display in tables 186 and 188, and sorting and sub-totaling in table 188.

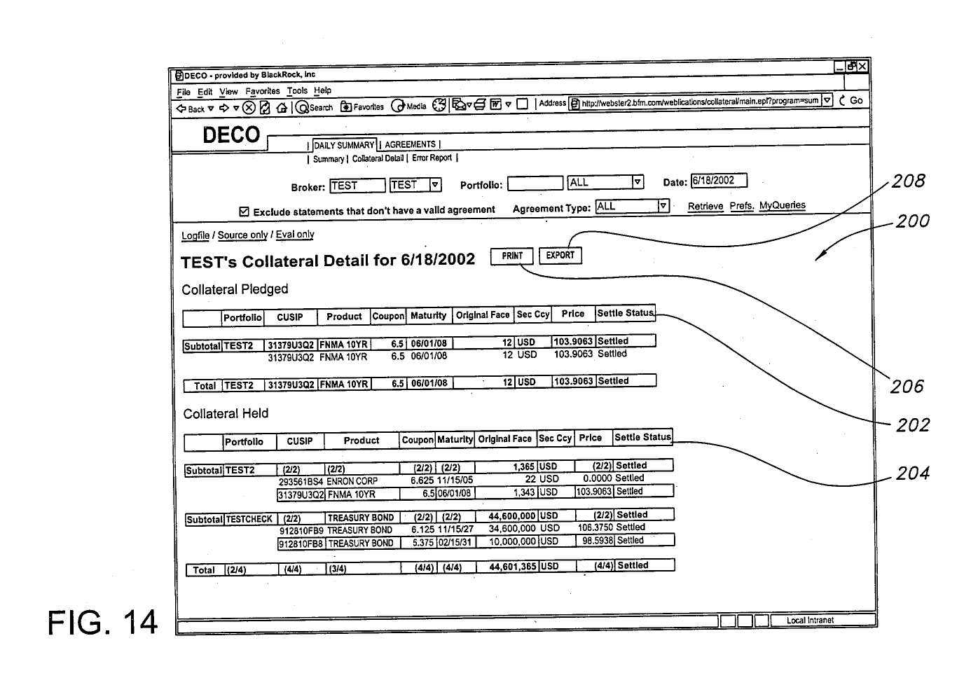

FIG. 14 illustrates a screen 200 that includes a collateral detail report in the form of summary tables 202 and 204 for collateral pledged and collateral held, respectively. The collateral detail report may be used to generate daily or month-end collateral position reports for all portfolios in database 24. In this embodiment, the collateral balances are sub-totaled by fund and aggregated by CUSIP number. Print button 206 may be used to generate a print-friendly and/or email-friendly version of the report. Export button 208 may be used to export the report into a format suitable for other software.

In general, the present disclosure is directed to a method of managing collateral in accordance with agreed upon terms in a system integrated with analytical and financial instrument trading systems. Although exemplary and preferred aspects and embodiments of the present disclosure have been described with a full set of features, it is to be understood that the disclosed system and method may be practiced successfully without the incorporation of each of those features. It is to be further understood that modifications and variations may be utilized without departure from the spirit and scope of this inventive system and method, as those skilled in the art will readily understand. Such modifications and variations are considered to be within the purview and scope of the appended claims and their equivalents.

What is claimed is:

1. A method of managing collateral in conjunction with an integrated trading system and an integrated analytics system, comprising the steps of:
a) receiving terms of an agreement relating to collateral support for a transaction involving two parties and financial instruments, wherein the terms include collateral held having a determinable present value, collateral pledged having a determinable present value, and a threshold exposure value for transferring the collateral support between collateral held and collateral pledged;
b) storing the terms of the agreement as data in an agreement database;
c) computing an exposure value representing the risk of financial loss associated with the transaction;
d) comparing the computed exposure value with the threshold exposure value; and
e) initiating a transfer of collateral based on the comparison of the computed value with the threshold exposure value.

2. A method according to claim 1, further comprising the step of associating the agreement data with portfolio data stored in a portfolio database relating to a portfolio of financial instruments.

3. A method according to claim 1, wherein the step of initiating a transfer of collateral based on the comparison further comprises initiating a transfer of collateral equal to the difference between the computed exposure value and the threshold value.

4. A method according to claim 3, further comprising the step of initiating the transfer of collateral from collateral held to collateral pledged if the difference between the computed exposure value and the threshold value is positive.

5. A method according to claim 3, further comprising the step of initiating the transfer of collateral from collateral pledged to collateral held if the difference between the computed exposure value and the threshold value is negative.

6. A method according to claim 1, further comprising the step of providing a graphical user interface for entering the terms of the agreement therein.

7. A method according to claim 1, further comprising the step of communicating the result of the comparison to the parties involved in the agreement.

8. A method according to claim 1, wherein the step of storing the terms of the agreement as data in an agreement database further comprises storing a minimum incremental amount for collateral transfer.

9. A method according to claim 8, wherein the step of initiating a transfer of collateral based on the comparison further comprises initiating a transfer of collateral equal to the minimum incremental amount if the difference between the computed exposure value and threshold value is equal to or greater than the minimum incremental amount.

10. A method according to claim 1, wherein the step of generating an exposure value representing the risk of financial loss associated with the transaction further comprises accessing current financial data using the integrated analytics system.

11. A method according to claim 1, wherein the step of initiating a transfer of collateral based on the comparison further comprises effectuating the transfer through the integrated trading system.

12. A collateral management system integrated with financial instrument trading and analytics system components, the collateral management system comprising:
a) means for receiving terms of an agreement relating to collateral support for a transaction involving two parties and financial instruments, wherein the terms include collateral held having a determinable present value, collateral pledged having a determinable present value, and a threshold exposure value for transferring the collateral support between collateral held and collateral pledged;
b) an agreement database for storing the terms of the agreement as agreement data;
c) means for computing an exposure value representing the risk of financial loss associated with the transaction;
d) means for comparing the computed exposure value with the threshold exposure value; and
e) means for initiating a transfer of collateral based on the comparison of the computed exposure value with the threshold exposure value.

13. A collateral management system as recited in claim 12, further comprising a portfolio database including data relating to portfolios of financial instruments.

14. A collateral management system as recited in claim 13, wherein the agreement data is associated with a portfolio in the portfolio database.

15. A collateral management system as recited in claim 12, further comprising means for communicating the results of the comparison to the parties.

16. A collateral management system as recited in claim 12, wherein the means for communicating the results of the comparison to the parties is the world wide web.

17. A collateral management system as recited in claim 12, wherein the means for initiating a transfer of collateral based on the comparison is through an associated trading system.

18. A collateral management system as recited in claim 12, wherein means for generating an exposure value representing the risk of financial loss associated with the transaction is a data processor.

19. A collateral management system as recited in claim 12, wherein means for receiving terms of an agreement relating to collateral support for a transaction involving two parties and financial instruments is a graphical user interface.

20. A machine readable media for facilitating collateral management in support of transactions involving financial instruments, comprising:
a) a data segment for,
i) storing data relating to agreements governing collateral management relating to the transactions in an agreements database;
ii) storing data relating to a plurality of collateral and thresholds for initiating transfers of collateral from collateral held to collateral pledged;
b) a code segment for,
i) performing an analysis of the transactions to determine credit risk exposure values relating to the transactions;
ii) comparing whether the credit risk exposure values are greater than the threshold values; and
iii) initiating a transfer of collateral based on the comparison of the determined credit risk exposure values to the threshold values.
